(19) United States
(12) Patent Application Publication
(10) Pub. No.: US 2024/0373394 A1
(43) Pub. Date: Nov. 7, 2024

(54) SYSTEMS AND METHODS FOR SIDELINK POSITIONING ACCURACY

(71) Applicant: Samsung Electronics Co., Ltd., Suwon-si (KR)

(72) Inventors: Yuhan Zhou, San Diego, CA (US); Philippe Jean Marc Michel Sartori, Naperville, IL (US); Yaser Mohamed Mostafa Kamal Fouad, San Diego, CA (US)

(21) Appl. No.: 18/651,179

(22) Filed: Apr. 30, 2024

Related U.S. Application Data
(60) Provisional application No. 63/463,253, filed on May 1, 2023.

(51) Int. Cl. H04W 64/00; G01S 5/02; H04W 56/00

(52) U.S. Cl. CPC H04W 64/00; G01S 5/021; G01S 5/0289; H04W 56/0015

(57) ABSTRACT

A system and a method are disclosed. The method includes performing, by a first user equipment (UE), a first measurement between a second UE and a third UE, receiving status data from the third UE, the status data including synchronization information associated with the third UE, based on the status data, selecting the third UE for determining the first measurement, and performing a positioning determination based on the first measurement.

This application claims priority to and the benefit under 35 U.S.C. § 119 (e) of U.S. Provisional Application No. 63/463,253, filed on May 1, 2023, entitled “ON THE MITIGATION OF TRANSMISSION ERROR FOR SL-TDOA” the entire disclosure of which is incorporated by reference herein.

### BACKGROUND

### 1. Field

Aspects of embodiments of the present disclosure relate to wireless communications. For example, aspects of embodiments of the present disclosure relate to systems and methods for improved sidelink (SL) positioning accuracy.

### 2. Description of the Related Art

Modern communication devices (e.g., mobile phones, vehicles, laptops, and the like), also known as UEs (user equipment), may perform SL positioning to determine their location (e.g., their geographic location). For example, an application running on a UE may request the UE's location. The UE may perform SL positioning because the UE may not have access (e.g., direct access) to a network node (e.g., a base station) and/or because the UE may not have access to a global navigation satellite system (GNSS) for directly accessing location information. Through SL positioning, the UE may determine its location based on neighboring UEs. As part of SL positioning, the UE may cause a communication system associated with the UE to send signals to the UE for performing a sidelink time difference of arrival (SL-TDOA) process.

The above information disclosed in this Background section is for enhancement of understanding of the background of the present disclosure, and, therefore, it may contain information that does not constitute prior art.

### SUMMARY

As discussed above, a UE may perform SL positioning because the UE may not have access to a network node (e.g., a base station), and/or because the UE may not have access to a global navigation satellite system (GNSS) from which to access (e.g., to directly access) location information. For example, a UE may be in a tunnel or in an underground parking structure, and the UE may lose connection to the base station or the GNSS, or the signal connecting the UE to the base station or to the GNSS may become too weak for satisfactory positioning accuracy. Through SL positioning, the UE may determine its location based on neighboring UEs. As part of SL positioning, the UE may cause a communication system associated with the UE to send signals to the UE for performing a sidelink time difference of arrival (SL-TDOA) process.

SL positioning accuracy may depend, at least in part, on transmission timing errors (e.g., synchronization errors and/or clock-drift errors) associated with neighboring UEs that are selected to participate in the SL-TDOA process. Such neighboring UEs may be referred to as anchor UEs.

To overcome these issues, systems and methods are described herein for improving SL positioning accuracy by: (i) mitigating the impact of synchronization errors within a communication system by exchanging synchronization status data between the neighboring UEs, between the neighboring UEs and the target UE for which location information is being requested, and/or between the UEs and a location management function (LMF) server; (ii) mitigating the impact of clock drift associated with anchor UEs; (iii) mitigating the impact of synchronization errors within a communication system by using multiple antennas from a single target UE; and/or (iv) mitigating the impact of synchronization errors within a communication system by using a positioning reference unit (PRU).

According to some embodiments of the present disclosure, a method includes performing, by a first user equipment (UE), a first measurement between a second UE and a third UE, receiving status data from the third UE, the status data including synchronization information associated with the third UE, based on the status data, selecting the third UE for determining the first measurement, and performing a positioning determination based on the first measurement.

The first UE may serve as a target UE, the second UE may serve as a reference UE, the third UE may serve as an anchor UE, and the synchronization information may include at least one of a synchronization source type associate with the third UE or a relative time difference (RTD) associated with the second UE and the third UE.

The target UE may have a position to be determined and may perform the first measurement, the reference UE may have a known position and may send a first signal to the target UE for performing the first measurement, and the anchor UE may participate in the first measurement by sending a second signal to the target UE for performing the first measurement.

The synchronization information may indicate a length of time since the third UE synchronized with a synchronization source.

The synchronization information may indicate a synchronization-source quality.

The method may further include performing, by the first UE, a second measurement between the second UE and the third UE, and sending, by the first UE, an indication that the first measurement or the second measurement can be used to determine a clock drift of the first UE.

The method may further include sending, by the first UE, the first measurement and the second measurement in a same message.

The method may further include sending, by the first UE, the first measurement and the second measurement in different messages.

The method may further include performing, by a positioning reference unit (PRU), a second measurement between the second UE and the third UE, and associating the first measurement with the second measurement.

The first UE may include a first antenna and a second antenna separated from each other by a distance, the performing the first measurement may include performing the first measurement with respect to the first antenna, and the method may further include performing a second measurement with respect to the second antenna, and determining a position of the first UE based on the first measurement, based on the second measurement, and based on the distance.

According to other embodiments of the present disclosure, a first user equipment (UE) includes a processing circuit, wherein the processing circuit is configured to perform a first measurement between a second UE and a third UE, receiving status data from the third UE, the status data including synchronization information associated with the third UE, based on the status data, selecting the third UE for determining the first measurement, and a positioning determination based on the first measurement.

The synchronization information may include at least one of a synchronization source type associated with the third UE or a relative time difference (RTD) associated with the second UE and the third UE.

The synchronization information may indicate a length of time since the third UE synchronized with a synchronization source, or a synchronization-source quality.

The processing circuit may be configured to perform a second measurement between the second UE and the third UE, and may send an indication that the first measurement or the second measurement can be used to determine a clock drift of the first UE.

According to other embodiments of the present disclosure, a system includes a processing circuit, and a memory for storing instructions, which, when executed by the processing circuit, cause the processing circuit to perform causing a first user equipment (UE) to perform a first measurement between a second UE and a third UE, receiving status data from the third UE, the status data including synchronization information associated with the third UE, based on the status data, selecting the third UE for determining the first measurement, and a positioning determination based on the first measurement.

The synchronization information may include at least one of a synchronization source type associated with the third UE or a relative time difference (RTD) associated with the second UE and the third UE.

The synchronization information may indicate a length of time since the third UE synchronized with a synchronization source.

The synchronization information may indicate a synchronization-source quality.

The instructions, when executed by the processing circuit, may cause the processing circuit to perform causing the first UE to perform a second measurement between the second UE and the third UE, and may cause the first UE to send an indication that the first measurement or the second measurement can be used to determine a clock drift of the first UE.

The instructions, when executed by the processing circuit, may cause the processing circuit to perform causing the first UE to send the first measurement and the second measurement in a same message.

### BRIEF DESCRIPTION OF THE DRAWINGS

The above and other aspects of the present disclosure will be more clearly understood from the following detailed description of the illustrative, non-limiting embodiments with reference to the accompanying drawings.

FIG. 1 is a block diagram depicting a system for performing SL positioning, according to some embodiments of the present disclosure.

FIG. 2 is a block diagram depicting a system for performing an SL-TDOA process between one target UE and two anchor UEs, according to some embodiments of the present disclosure.

FIG. 3A is a flowchart depicting a method for mitigating an impact of clock drift based on a target UE receiving a request to perform a reference signal time difference measurement (an RSTD measurement) and to perform a drift-related evaluation, wherein the drift-evaluation request is received before a first RSTD measurement, according to some embodiments of the present disclosure.

FIG. 3B is a flowchart depicting a method for mitigating an impact of clock drift based on a target UE receiving a request to perform an RSTD measurement and to perform a drift-related evaluation, wherein the drift-evaluation request is received after the first RSTD measurement, according to some embodiments of the present disclosure.

FIG. 4 is a block diagram depicting a system for mitigating an impact of synchronization errors using multiple antennas from a single target UE, according to some embodiments of the present disclosure.

FIG. 5 is a block diagram depicting a system for mitigating an impact of synchronization errors using a positioning reference unit (PRU), according to some embodiments of the present disclosure.

FIG. 6 is a flowchart depicting a method for performing SL positioning, according to some embodiments of the present disclosure.

FIG. 7 is a block diagram of an electronic device in a network environment, according to some embodiments of the present disclosure.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one or more embodiments” or “an embodiment” means that a particular feature, structure, or characteristic described in connection with the embodiment may be included in at least one or more embodiments disclosed herein. Thus, the appearances of the phrases “in one or more embodiments” or “in an embodiment” or “according to one or more embodiments” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the terms “or” and “and/or” include any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and case of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

The electronic or electric devices and/or any other relevant devices or components according to embodiments of the present disclosure described herein may be implemented utilizing any suitable hardware, firmware (e.g., an application-specific integrated circuit (ASIC)), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

Sidelink time difference of arrival (SL-TDOA) is a method of positioning to identify a position, or a geographic location, of a UE. To perform SL TDOA, a target UE may measure a reference signal time difference (RSTD) using a sidelink positioning reference signal (SL PRS) from at least two different UEs (e.g., a reference UE and an anchor UE). Performing positioning based on SL TDOA may also be referred to as performing a positioning on a sidelink (SL). As used herein, a “sidelink” is a communication link between two UEs.

For example, to determine the location of a target UE, a reference UE, having a high quality of synchronization with the network, may send a first signal to the target UE for performing a first measurement (e.g., a first reference signal time difference (RSTD) measurement). The reference UE may have a known location based on having the high quality of synchronization with the network. An anchor UE may be selected to participate in determining the location of the target UE. The anchor UE may participate by sending a second signal to the target UE for performing the first measurement.

To achieve high positioning accuracy, it may be suitable for a system to mitigate the impact of transmission timing errors. RSTD-estimation error may depend on several factors, including: (i) the synchronization error of the SL transmission, which may depend on the quality of a synchronization source/sync source (e.g., may depend on whether anchor UEs are directly or indirectly synchronized to a GNSS, a gNodeB/gNB, and/or the like); (ii) the length of time since the anchor UEs were last synchronized with the sync source; and (iii) a clock drift at the anchor UE and the target UE. As used herein, “clock drift” refers to a change (e.g., a slight change) in a clock's timing based on the clock running too slowly or too quickly.

According to the Third Generation Partnership Project (3GPP) specification 38.133 (hereinafter the “3GPP Spec”), when a GNSS is used as a synchronization source for an SL-TDOA process, the resulting timing error may be about 391 nanoseconds (ns), which may correspond to about 117 meters (m) in estimation error. In other words, a target UE may only be determined to be located within a region having a radius of about 117 m. It may be suitable for the target UE's location to be determined within a radius of less than about 1 m for high positioning accuracy.

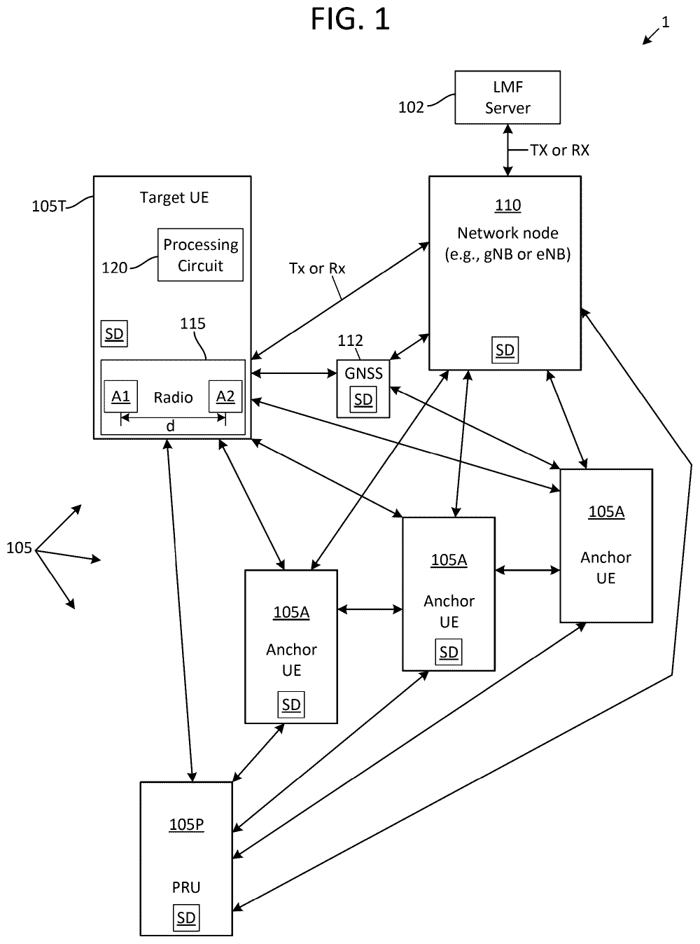

FIG. 1 is a block diagram depicting a system for performing SL positioning, according to some embodiments of the present disclosure.

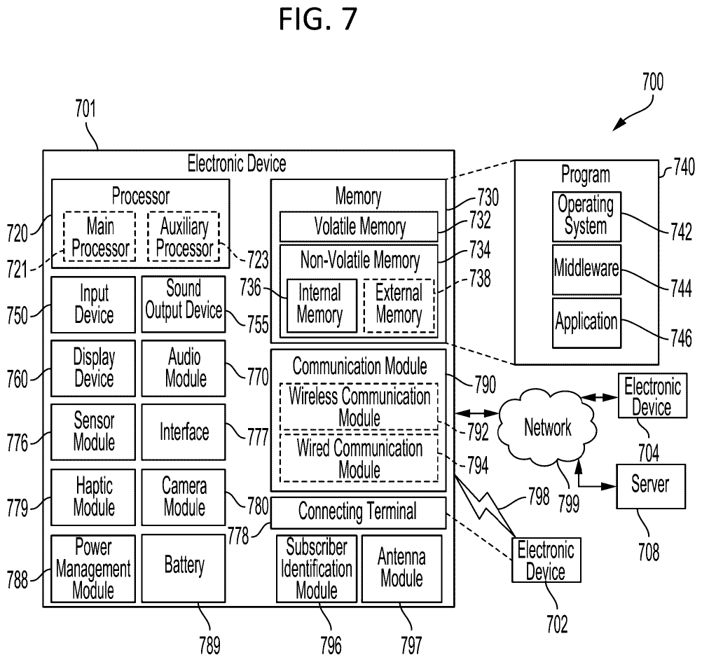

Referring to FIG. 1, a system 1 for performing SL positioning may include UEs 105, a network node 110 (e.g., a gNodeB, or an eNodeB, also referred to as a “base station”), a location management function (LMF) server 102, and a GNSS 112. Each UE 105 may correspond to the electronic device 701 of FIG. 7. The network node 110 may correspond to the first network 798 or the second network 799 of FIG. 7. The GNSS 112 may correspond to the first network 798 or the second network 799 of FIG. 7. The LMF server 102 may correspond to the server 708, the first network 798, or the second network 799 of FIG. 7.

The UEs 105, the network node 110, the LMF server 102, and the GNSS 112 may be communicatively coupled to each other. For example, each UE 105 may be able to transmit (Tx) signals to and/or receive (Rx) signals from other UEs 105. Each UE 105 may be able to transmit signals to, and/or receive signals from, the network node 110, the GNSS 112, and/or the LMF server 102. For example, each UE 105 may be able to transmit signals to and/or receive signals from the LMF server 102 through the network node 110.

Each UE 105 may include a radio 115 and a processing circuit 120 (e.g., a means for processing), which may perform various methods disclosed herein (e.g., the methods illustrated in FIGS. 1-6). The processing circuit 120 may correspond to the processor 720 of FIG. 7. The radio 115 may correspond to the communication module 790 of FIG. 7. Via the radio 115, the processing circuit 120 may receive transmissions from the network node 110, and/or the processing circuit 120 may transmit signals to the network node 110.

Each UE 105 may include one or more antennas. For example, a UE 105 may include a first antenna A1 and a second antenna A2. The first antenna A1 may be separated from the second antenna A2 by a distance d. The first antenna A1 and the second antenna A2 may correspond to the antenna module 797 of FIG. 7.

The UEs 105 may include a target UE 105T and two or more anchor UEs 105A. For example, during an SL-TDOA process, the target UE 105T may try to determine its own location. At least two additional UEs 105 may be selected as the anchor UEs 105A to assist with determining the location of the target UE 105T. For example, one or more of the anchor UEs 105A may be selected from a list of neighbor UEs (e.g., a list of UEs neighboring the target UE 105T). As discussed in further detail below, the anchor UEs 105A may send signals to the target UE 105T as part of the SL-TDOA process. For example, the anchor UEs 105A may send SL PRS to the target UE 105T. The target UE 105T may perform a measurement (or measurements) on the signals received from the anchor UEs 105A. The target UE 105T may derive its location based on the measurement (or measurements). For example, the target UE 105T may perform RSTD measurements on the SL PRS received from the anchor UEs. The target UE 105T may obtain relative time difference (RTD) information from the RSTD measurements and may derive errors from the RTD information. In some embodiments, the target UE 105T may choose which UEs 105 participate as anchor UEs 105A. When the target UE 105T calculates its own location, the positioning may be referred to as UE-based positioning. In some embodiments, the LMF server 102 may choose which UEs 105 participate as anchor UEs 105A. When the location of the target UE 105T is calculated at the LMF server 102, the positioning may be referred to as UE-assisted positioning. In some embodiments, the UEs 105 may determine whether to participate as anchor UEs 105A. In some embodiments, one or more of the anchor UEs 105A may be a reference UE. The reference UE may be a UE 105 having a high quality of synchronization (e.g., perfect synchronization) with the network.

In some embodiments, the first antenna A1 and the second antenna A2 of the target UE 105T may be used to determine the location of the of the target UE 105T. For example, as discussed in further detail below, the target UE 105T may perform measurements on signals sent by anchor UEs 105A that are received at the first antenna A1 and the second antenna A2. Based on knowing the distance d between the first and second antennas A1 and A2, the target UE 105T may determine its location.

A UE 105 may be a positioning reference unit (PRU) 105P. In some embodiments, the PRU 105P may be used to determine the location of the target UE 105T. The PRU 105P may be a special UE that knows its location accurately (e.g., perfectly or nearly perfectly). For example, the PRU 105P may be a mounted device that stores its precise location, and that is expected not to be moved (e.g., can be expected to have a fixed position). In some embodiments, the PRU 105P may be used when a reference UE is not available.

Each of the UEs 105 may be directly connected to or indirectly connected to one or more of the other UEs 105, to the network node 110, and/or to the GNSS 112. As discussed in further detail below, each of the UEs 105 may be associated with status data SD (e.g., synchronization information). For example, the GNSS 112 may be associated with status data SD indicating that it is a high-quality synchronization source. Likewise, the network node 110 may be associated with status data SD indicating that it is a high-quality synchronization source. A UE 105 that is directly connected to the GNSS 112 or directly connected to the network node 110 may be associated with status data SD indicating that it is a higher-quality synchronization source than a UE 105 that is indirectly connected to the GNSS 112 and/or the network node 110. As used herein, “directly connected” refers to an entity (e.g., a UE 105) that is connected to another entity (e.g., another UE 105, the GNSS 112, and/or the network node 110) without connecting to another intervening entity (e.g., another UE 105, the GNSS 112, and/or the network node 110). As used herein, “indirectly connected” refers to an entity (e.g., a UE 105) that is connected to another entity (e.g., another UE 105, the GNSS 112, and/or the network node 110) through one or more other entities. A UE 105 that is indirectly connected to the GNSS 112 through only one other UE 105 may be associated with status data SD indicating that it is a higher-quality synchronization source than another UE 105 that is indirectly connected to the GNSS 112 through two or more other UEs 105. As discussed in further detail below, each entity in the system 1 may be able to exchange its status data SD with any other entity in the system 1. For example, any UE 105 may be able to transmit (e.g., broadcast) its status data SD to the other UEs 105 and/or to the LMF server 102.

Referring still to FIG. 1, with TDOA (e.g., SL TDOA), the target UE 105T measures the time difference between two signals sent from two different network entities. To work well, the two network entities may be synchronized with a high accuracy. Otherwise, the time difference between the two network entities may be corrupted, and the corresponding positioning may be inaccurate. While it may be easy to achieve high accuracy if the two network entities are network nodes 110, high accuracy may be more challenging on the sidelink, where the two network entities are UEs 105. For example, the UEs 105 may have more relaxed synchronization standards than the network nodes 110.

There may be four basic sources, or synchronization references, from which a UE 105 (e.g., a vehicle-to-everything (V2X) UE) may derive its own synchronization: (1) the GNSS 112, (2) the network node 110, (3) another UE 105 that transmits a sidelink synchronization signal (SLSS) (e.g., a “SyncRef UE”), or (4) its own internal clock.

In general, the GNSS 112 or the network node 110 are regarded as the high/highest-quality synchronization sources. SyncRef UEs may include UEs 105 that are directly synchronized to the GNSS 112 or the network node 110, UEs 105 that are one step further away (e.g., indirectly synchronized) from the GNSS 112 or the network node 110, and/or UEs 105 that are two or more steps further away from the GNSS 112 or network node 110. If a UE 105 cannot find a higher-quality synchronization source, the UE 105 may attempt to synchronize with a SyncRef UE that is using its internal clock as a reference. As a last resort, if the UE 105 is unable to find any other synchronization reference, the UE 105 may use its own internal clock to transmit an SL synchronization signal block (S-SSB).

V2X synchronization procedures may provide a hierarchy (e.g., a set of priorities) among the above synchronization references. In accordance with such V2X synchronization procedures, a UE 105 may search (e.g., continuously search) the hierarchy (e.g., levels) to get to the highest-quality synchronization source it can find. In one or more embodiments, a general order/hierarchy may be the following levels 1-8: level 1 (the highest quality level) may include either GNSS or eNB/gNB according to configuration (e.g., pre-configuration); level 2 may include a SyncRef UE directly synchronized to a level 1 source; level 3 may include a SyncRef UE synchronized to a level 2 source (e.g., indirectly synchronized to a level 1 source); level 4 may include whichever of GNSS or eNB/gNB was not configured (e.g., pre-configured) as the level 1 source; level 5 may include a SyncRef UE directly synchronized to a level 4 source; level 6 may include a SyncRef UE synchronized to a level 5 source (e.g., indirectly synchronized to a level 4 source); level 7 may include any other SyncRef UE; and level 8 may include the internal clock of the UE 105.

The new radio (NR) V2X scheme may allow the merging of otherwise-separate hierarchies derived from GNSS and gNB/eNB. Accordingly, a UE may be able to move between nearby hierarchies without loss of sidelink service. However, because it is possible that a gNB/eNB itself may not have synchronization to a GNSS, the use of levels 4-6 may be disabled when GNSS is used as level 1. Doing so avoids deviations from the hierarchy being derived from GNSS. Alternatively, if the gNB/eNB is synchronized or loosely synchronized with the GNSS, levels 4-6 may be enabled when GNSS is used as level 1, because levels 4-6 may provide better performance than having a SyncRef UE.

A sidelink synchronization signal identification (SLSSID) itself may convey information about the synchronization source of a transmitting UE 105. In general, a UE 105 that is further away from a high-quality synchronization source (e.g., GNSS or gNB/eNB) will have a lower-quality synchronization and, thus, a lower-quality SLSS that the UE 105 transmits.

The standards of transmission timing for V2X sidelink communication are specified in the 3GPP Spec (e.g., TS 38.133). For example, a GNSS may be used as the synchronization reference source, a NR cell may be used as the synchronization reference source, an evolved universal mobile telecommunications system terrestrial radio access network (E-UTRAN) cell may be used as the synchronization reference source, and a SyncRef UE may be used as the synchronization reference source. With GNSS used as the synchronization source, the resulting timing error may be about 12*64*0.509=391 ns, which may result in about a 117 m estimation error in positioning. For example, as discussed above, a target UE 105T might be determined as having a location somewhere within a radius of about 117 m.

A system that relies on the SL-communication-defined synchronization sources may not achieve sufficient synchronization accuracy for SL-TDOA. Accurate synchronization may be achieved with means outside of 3GPP. Thus, it may be suitable for any device that receives SL PRS (e.g., in the case of uplink time difference of arrival (UL-TDOA), like SL TDOA), or that transmits SL PRS (e.g., in the case of downlink time difference of arrival (DL-TDOA)), to be highly synchronized. For example, roadside units (RSUs), may be connected to a backhaul, such that the RSUs are synchronized to a degree that the impact of the synchronization error on the SL TDOA performance is not detrimental (e.g., not significant).

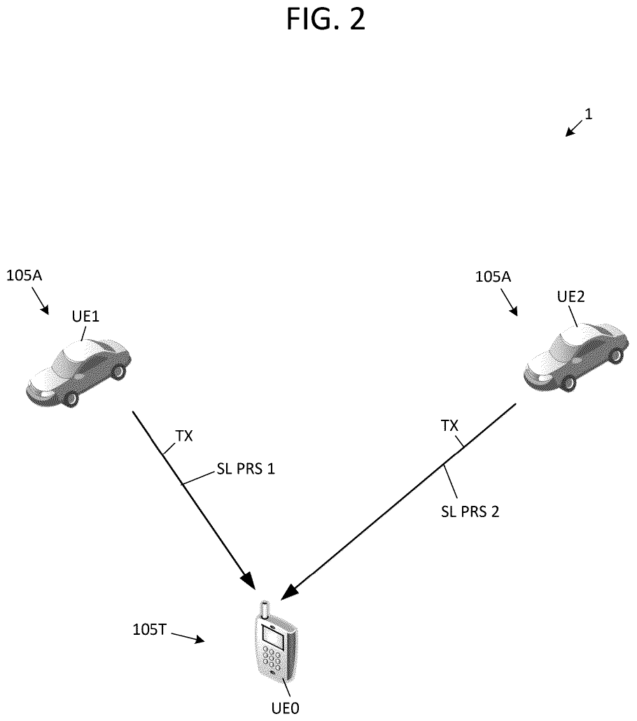

FIG. 2 is a block diagram depicting a system for performing an SL-TDOA process between one target UE and two anchor UEs, according to some embodiments of the present disclosure.

Referring to FIG. 2, the target UE 105T may be the UE performing an RSTD measurement (UE 0). The other UEs (UE1, UE2, etc.) may be the anchor UEs 105A. The anchor UEs 105A may be the UEs sending the SL PRS. For example, UE1 may send/transmit (Tx) SL PRS 1, and UE2 may send SL PRS 2.

The actual transmitting time at time t for UEi (assuming no resynchronization since tᵢ^{sync}) may be given by equation 0.1 below by assuming the following: the distance between UE0 and UEi (e.g., a given anchor UE 105A) is dᵢ; the clock drift rate for UEi is eᵢ; the time at which the latest synchronization alignment was done was tᵢ^{sync}; and the synchronization error of UEi at time tᵢ^{sync} is εᵢ.

$$= t + {e}_{i} ( t - {t}_{i}^{s y n c} ) + {ε}_{i} \qquad ( equation 0.1 )$$

Further, the actual transmission time for UEj (e.g., another given anchor UE 105A) may be given by equation 0.2 below.

$$= t + {e}_{j} ( t - {t}_{j}^{s y n c} ) + {ε}_{j} \qquad ( equation 0.2 )$$

Assuming that a receiving (Rx) time measured by UE0 for the PRS received from UEi is \hat{t}ᵢ+dᵢ/c (wherein c refers to the speed of light), and ignoring the second-order effect of clock drift during time of flight (because the propagation delay may be relatively small), an ideal RSTD without error between UEi and UEj may be denoted as RSTD_{i,j} and its estimation by UE0 may be denoted as R [symbol] _{i,j}, such that:

$$R {j}_{} = ( + {d}_{i} / c ) - ( + {d}_{j} / c ) = RST {D}_{i , j} + {e}_{i} ( t - {t}_{i}^{s y n c} ) + {ε}_{i} - {e}_{j} ( t - {t}_{j}^{s y n c} ) - {ε}_{j} . \qquad ( equation 0.3 )$$

The time error in RSTD estimation is thus (equation 0.4):

$$err ( i , j ) = {e}_{i} ( t - {t}_{i}^{s y n c} ) + {ε}_{i} - {e}_{j} ( t - {t}_{j}^{s y n c} ) - {ε}_{j} = ( {e}_{i} - {e}_{j} ) t + ( {e}_{j} {t}_{j}^{sync} - {e}_{i} {t}_{i}^{sync} ) + ( {ε}_{i} - {ε}_{j} )$$

Without loss of generality, assume that:

$${t}_{j}^{s y n c} = {t}_{i}^{s y n c} + Δ t \qquad ( equation 0.5 )$$

Then, the error in RSTD estimation by the target UE 105T may be determined based on:

$$err ( i , j ) = ( {e}_{i} - {e}_{j} ) ( t - {t}_{i}^{s y n c} ) + {e}_{j} Δ t + ( {ε}_{i} - {ε}_{j} ) \qquad ( equation 1. )$$

Referring to equation 1.0, the error in RSTD estimation may depend on the following terms: (1) the synchronization errors of UEi, εᵢ and UEj, εⱼ (e.g., the synchronization error of the sidelink transmission may depend on the transmission timing error and propagation delay between the relevant UE 105 (e.g., UEi or UEj) and its synchronization source, for both UEs 105 (e.g., UEi and UEj)); (2) a term depending on the time gap when the UEi and UEj are synchronized eⱼΔt; and (3) a term depending on the clock drift at UEi and UEj, (eᵢ−eⱼ)(t−tᵢ^{sync}).

The error in RSTD estimation may also depend on the synchronization source quality (e.g., whether a UE/UEi/UEj is directly or indirectly synchronized to a GNSS, a gNB, and/or the like).

Some of the terms in the transmission (Tx) time error may be mitigated or reduced. For example, the term including eⱼΔt (of equation 1.0) may be reduced by having the UEs synchronize at the same time, or at times that are very close to each other, aeᵢ−eⱼ, and by computing the RSTD very closely after the synchronization.

The term including (eᵢ−eⱼ)(t−tᵢ^{sync}) (of equation 1.0) may be eliminated, as discussed below, based on the assumption that the UEs do not move (e.g., assuming that the relative positions of the anchor UEs 105A and the target UE 105T do not change).

If it is assumed that RSTD₁ and RSTD₂ are measured for UE1 and UE2 at different times t₁ and t₂, then the corresponding errors of the two RSTD measurements, err₁(i,j), err₂(i,j) may be given by equations 1.1 and 1.2 below.

$$e r {r}_{1} ( i , j ) = ( {e}_{i} - {e}_{j} ) ( {t}_{1} - {t}_{i}^{s y n c} ) + {e}_{j} Δ {t}_{1} + ( {ε}_{i , 1} - {ε}_{j , 1} ) \qquad ( equation 1.1 )$$

$$er {r}_{2} ( i , j ) = ( {e}_{i} - {e}_{j} ) ( {t}_{2} - {t}_{i}^{s y n c} ) + {e}_{j} Δ {t}_{2} + ( {ε}_{i , 2} - {ε}_{j , 2} ) \qquad ( equation 1.2 )$$

where Δt₁ and Δt₂ represent the time difference of tⱼ^{sync}−tᵢ^{sync} between UE1 and UE2 at time t₁ and t₂, and ε_{i,t} represents the synchronization error for UEi at time t.

If the synchronization source of UE1 and UE2 does not change, if the locations of UE1 and UE2 are the same over time (e.g., both UEs do not move), if the environment is relatively static between UE1, UE2, and if the synchronization source (e.g., if they are synchronized to a gNB with line of sight), then:

$$Δ {t}_{1} = Δ {t}_{2} , {ε}_{i , 1} = {ε}_{i , 2} , and {ε}_{j , 1} = {ε}_{j , 2} . \qquad ( equation 1.3 )$$

$$Thus ,$$

$$RST {D}_{1} - R S T {D}_{2} = e r {r}_{1} ( i , j ) - e r {r}_{2} ( i , j ) = ( {e}_{i} - {e}_{j} ) ( {t}_{1} - {t}_{2} ) . \qquad ( equation 1.4 )$$

$$Then$$

$${e}_{i} - {e}_{j} = \frac{R S T {D}_{1} - R S T {D}_{2}}{{t}_{1} - {t}_{2}} . \qquad ( equation 1.5 )$$

If the quantity eᵢ−eⱼ, which is related to clock drift rate, is known, and if the elapsed time between the transmission and last synchronization is measured at the transmitting (Tx) UE, then the term including (eᵢ−eⱼ) (t−tᵢ^{sync}) in the RSTD measurement error can be suitably removed. In addition, while the impact of synchronization errors in the RSTD measurement may not be eliminated, such errors may be reduced (e.g., by directly or indirectly indicating the synchronization source) so that the RSTD accuracy can be improved. In other words, at the very least, the quality of the synchronization may be indicated.

As discussed above, there are three terms in the transmission error (equation 1.0) for RSTD calculation in SL-TDOA. Two terms in the transmission error are related to the clock drift at a transmitting UE (e.g., UE1 or UE2), and another term is related to the synchronization error when the transmitting UE (e.g., UE1 or UE2) is synchronized with a synchronization source.

In some embodiments of the present disclosure, to mitigate the impact of errors due to clock drift, the UEs 105 may report time information indicating the time when they last synchronized with a synchronization source (e.g., GNSS, gNB, or a reference UE). In some embodiments, the time information may include a timestamp associated with a time instance when the UE 105 last synchronized with the synchronization source. In some embodiments, the time information may include the elapsed time between the transmission time instance and the time instance when the UE 105 last performed synchronization. If the UE 105 has a timer for recording the time since the UE 105 synchronized with a synchronization source, the time information may include the timer value or any combination of the following: (1) the direct frame number (DFN); (2) the subframe index; and/or (3) the slot index in which the last synchronization was achieved.

In some embodiments, information indicating synchronization quality may be included in first-stage sidelink control information (SCI), second-stage SCI, medium access control (MAC) control element (CE), radio resource control (RRC) configuration, or assistant data for positioning. To reduce overhead, in some embodiments, a UE 105 may report the difference between a current value and a last measured value (e.g., a UE 105 may perform differential reporting). In some embodiments, the UE 105 may report the absolute value of the elapsed time since the last synchronization.

In SL TDOA, to mitigate the impact of synchronization errors between anchor UEs 105A, in some embodiments, the target UE 105T and/or the anchor UEs 105A may be configured to indicate one or more of the following: synchronization source information (e.g., SLSSID); synchronization source quality, which may be transmitted in the SCI or assistant data; and/or UE location estimation (e.g., an expected UE location and its variance), which may be transmitted in the assistant data. In some embodiments, the synchronization source information and/or synchronization source quality may be carried in the SCI or assistant data. The synchronization quality information may include the following: (1) whether the UE 105 directly or indirectly synchronized with the synchronization source; (2) the clock-drift rate for the UE 105; (3) the timestamp for the time when the UE 105 last synchronized with the synchronization source; (4) the timer value, indicating the elapsed time between the transmission time and the time when UE 105 performed its last synchronization; (5) the expected value and variance of the transmission-time error of the UE 105; (6) the communication-link quality between the UE 105 and the sync source, including (a) the number of hops (e.g., the number of intervening entities) for transmission between the UE 105 and synchronization source, and (b) an indication of wired connection or wireless connection for each hop between the UE and the sync source.

In some embodiments, an anchor UE 105A may indicate its location estimation and its relative accuracy along with the transmission of the PRS to the LMF server 102 (see FIG. 1).

In some embodiments, to reduce the overhead, there may be provided information on the elapsed time since last synchronization based on an explicit request by the target UE 105T. In some embodiments, to reduce the overhead, the information on the elapsed time since last synchronization may be provided by default once a positioning service is triggered by a higher layer of the system 1. For example, the target UE 105T may dynamically request the elapsed time since the last synchronization to be present. This dynamic request may be carried in the first-stage SCI, the second-stage SCI, MAC control element (MAC CE), or RRC configuration when establishing a sidelink between the target UE 105T and the anchor UEs 105A.

In some embodiments, the information on the elapsed time may also depend on the frequency of synchronization signal block (SSB) transmissions. For example, if the distance in slots between two consecutive SSB transmissions is below a threshold (e.g., a threshold per resource pool), then a UE 105 may provide the elapsed time since its last synchronization.

As discussed above, the term (eᵢ−eⱼ)(t−tᵢ^{sync}) in equation 1.0 is the relative clock drift between the two transmitting anchor UEs 105A. This term may be completely removed by having the target UE 105T report the difference of two RSTD measurements. The difference of the two RSTD measurements may be determined by measuring the RSTD at two different times, assuming that the UEs 105 have remained at the same location and that the synchronization source remains the same. For example, if the relative locations of the anchor UEs 105A and the target UE 105T and the synchronization source remains the same, the clock-drift term may be eliminated.

A UE 105 may simply send two RSTD measurements at two different times, which may reduce or minimize effort involved with standardization because the existing messaging of the access (Uu) link could potentially be extended for the sidelink. However, simply sending two RSTD measurements at two different times may lead to inaccurate results. For example, if an anchor UE 105A has resynchronized between the two measurements, the target UE 105T may not be able to measure the clock drift. Additionally, if the UE 105 experiences different (e.g., significantly different) channel conditions between the two measurements, the difference in RSTD may not be used to derive the drift. For example, different channel conditions may occur based on the locations of the anchor UEs 105A changing, based on line-of-sight (LOS) conditions and/or non-line-of-sight (NLOS) conditions changing for the channel, or based on the synchronization source changing.

To avoid these issues, the two RSTD measurements may be linked so that the target UE 105T measuring the two RSTDs may determine that the purpose of the linked RSTDs is to measure the clock drift. To link the two RSTDs, two methods may be implemented. In some embodiments, a single message (e.g., a same message) may be used to trigger the target UE 105T to perform two linked RSTD measurements. In some embodiments, two different messages may be sent with an indication that the two messages are linked.

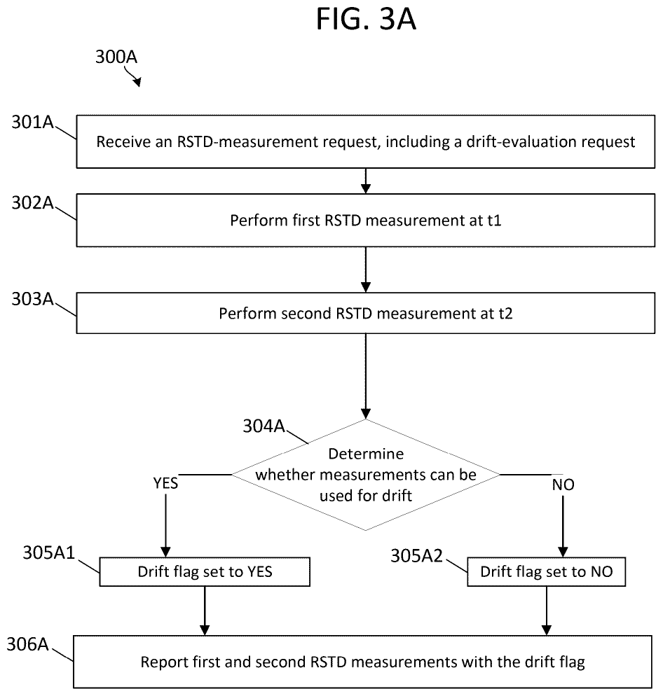

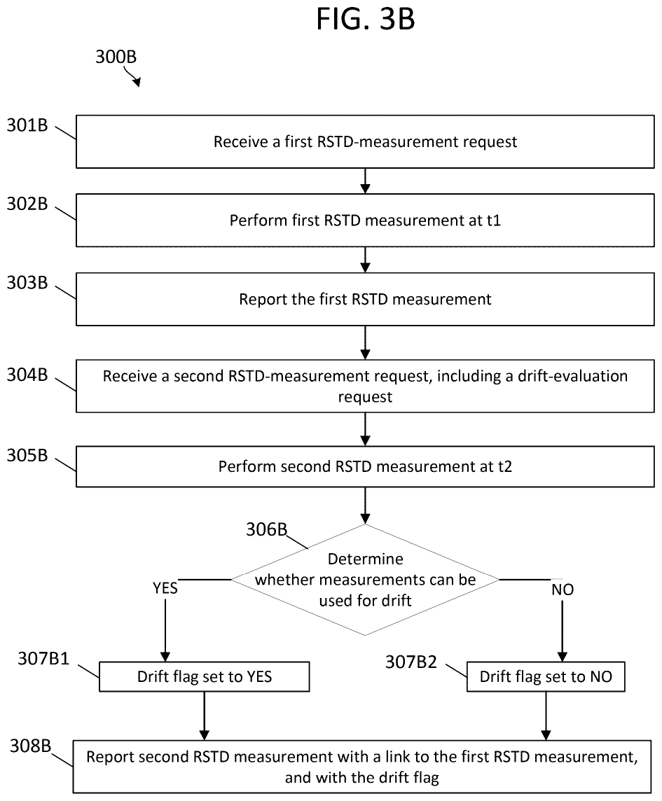

FIG. 3A is a flowchart depicting a method for mitigating an impact of clock drift based on a target UE receiving a request to perform an RSTD measurement and to perform a drift-related evaluation, wherein the drift-evaluation request is received before a first RSTD measurement, according to some embodiments of the present disclosure.

Referring to FIG. 3A, the method 300A to perform RSTD measurements, to perform a clock drift evaluation, and to reduce clock-drift errors, may include the following operations. The target UE 105T may first receive an RSTD-measurement request, which may include a drift-evaluation request (operation 301A). The trigger for performing the first RSTD measurement may be an RRC message or an MAC CE. The request may be carried in the first-stage SCI or the second-stage SCI. The request may be sent by an anchor UE 105A, by the network node 110, or by a neighboring UE 105. The request message (e.g., an implicit request or explicit request) may include one or more of the following: (i) a time to measure the first RSTD t₁; (ii) a time to measure the second RSTD t₂; or (iii) a flag (e.g., a drift-request flag, such as “DRIFT_REQUEST”), requesting that the target UE 105T indicate whether the clock drift may be evaluated or not. In some embodiments, time stamps t₁, t₂, which indicate when the measurements are to be performed, may be explicitly provided by the LMF server 102 and/or the network node 110 to the target UE 105T. In some embodiments, the LMF server 102 and/or the network node 110 may configure a time window within which the target UE 105T may send the two RSTD measurements. In some embodiments, the time window may be relatively short (e.g., on the order of milliseconds). The target UE 105T may perform a first RSTD measurement at a first time t1 (operation 302A). The target UE 105T may perform the second RSTD measurement at a second time t2 (operation 303A). The target UE 105T may perform the first RSTD measurement and/or the second RSTD measurement using any protocol known to one of ordinary skill in the art. The target UE 105T may determine whether the first RSTD measurement and/or the second RSTD measurement may be used to determine clock drift (e.g., is capable of being used to determine a clock drift) (operation 304A).

For example, and as discussed above, if (i) the relative locations of the UEs have changed, if (ii) a re-synchronization has occurred between the first RSTD measurement and the second RSTD measurement, or if (iii) the channel has changed significantly between the first RSTD measurement and the second RSTD measurement, then it may not be possible to use the difference in RSTD to measure the clock drift. In such cases, the target UE 105T may set a drift flag to NO (e.g., may set a bit position to indicate NO) (operation 305A2). The drift flag may provide (e.g., may be) an indication of whether a given RSTD measurement can be used to determine a clock drift of a target UE. In some embodiments, the UE may determine whether the channel has changed significantly based on determining a distance associated with two channel measurements and comparing the distance to a threshold distance.

On the other hand, if (i) the relative locations of the UEs have not changed, if (ii) a re-synchronization has not occurred between the first RSTD measurement and the second RSTD measurement, and if (iii) the channel has not changed significantly between the first RSTD measurement and the second RSTD measurement, then the target UE 105T may set the drift flag to YES (e.g., may set a bit position to indicate YES) (operation 305A1). The target UE 105T may report the first RSTD measurement and the second RSTD measurement along with the drift flag (operation 306A).

The present disclosure is not limited to the sequence or number of the operations of the method 300A shown in FIG. 3A, and can be altered into any desired sequence or number of operations as recognized by a person having ordinary skill in the art. For example, in some embodiments, the order may vary, some processes thereof may be performed concurrently or sequentially, or the method 300A may include fewer or additional operations.

In some embodiments, the target UE 105T may report the RSTD measurements in a single message (e.g., a same message) including both RSTD measurements and the drift flag (e.g., including RSTD1, RSTD2, and DRIFT). Other reporting formats may include reporting the difference between the two RSTD measurements and the drift flag (e.g., RSTD2-RSTD1, DRIFT). The reporting may occur as an MAC CE or as an RRC message.

FIG. 3B is a flowchart depicting a method for mitigating an impact of clock drift based on a target UE receiving a request to perform an RSTD measurement and to perform a drift-related evaluation, wherein the drift-evaluation request is received after the first RSTD measurement, according to some embodiments of the present disclosure.

Referring to FIG. 3B, the method 300B to perform linked RSTD measurements, and to perform a clock drift evaluation for reducing clock-drift errors, may include the following operations. The target UE 105T may receive a first RSTD-measurement request, which may not include a drift-evaluation request (operation 301B). The trigger for performing the first RSTD measurement, may be an RRC message, may be an MAC CE, or the request may be carried in the first-stage SCI or the second-stage SCI. The request may be sent by an anchor UE 105A, by the network node 110, or by a neighboring UE 105. The target UE 105T may perform a first RSTD measurement at a first time t1 (operation 302B). The target UE 105T may report the first RSTD measurement (operation 303B). The target UE 105T may receive a second request to perform an RSTD measurement, which may include a drift-evaluation request (operation 304B). The target UE 105T may perform the second RSTD measurement at a second time t2 (operation 305B). The target UE 105T may perform the first RSTD measurement and/or the second RSTD measurement using any protocol known to one of ordinary skill in the art. The target UE 105T may determine whether the second RSTD measurement may be used to determine clock drift (e.g., is capable of being used to determine a clock drift) with respect to (e.g., in connection with) the first RSTD measurement (operation 306B).

For example, and as discussed above, if (i) the relative locations of the UEs have changed, if (ii) a re-synchronization has occurred between the first RSTD measurement and the second RSTD measurement, or if (iii) the channel has changed significantly between the first RSTD measurement and the second RSTD measurement, then it may not be possible to use the difference in RSTD to measure the clock drift. In such cases, the target UE 105T may set a drift flag to NO (e.g., may set a bit position to indicate NO) (operation 307B2). In some embodiments, the UE may determine whether the channel has changed significantly based on determining a distance associated with two channel measurements and comparing the distance to a threshold distance.

On the other hand, if (i) the relative locations of the UEs have not changed, if (ii) a re-synchronization has not occurred between the first RSTD measurement and the second RSTD measurement, and if (iii) the channel has not changed significantly between the first RSTD measurement and the second RSTD measurement, then the target UE 105T may set the drift flag to YES (e.g., may set a bit position to indicate YES) (operation 307B1). The target UE 105T may report the second RSTD measurement with a link to the first RSTD measurement, and with the drift flag (operation 308B).

The present disclosure is not limited to the sequence or number of the operations of the method 300B shown in FIG. 3B, and can be altered into any desired sequence or number of operations as recognized by a person having ordinary skill in the art. For example, in some embodiments, the order may vary, some processes thereof may be performed concurrently or sequentially, or the method 300B may include fewer or additional operations.

In some embodiments, two different messages may be sent with an indication that the two messages are linked. The target UE (e.g., UE0 of FIG. 2) may measure the RSTD between anchor UE1 and anchor UE2. If the synchronization error between the anchor UEs is not negligible, then there is an error in the RSTD measurement. However, if the synchronization source of the anchor UEs 105A does not change, and if the relative locations of anchor UEs 105A do not change, then the synchronization error may not change either, and the two RSTD measurements may be linked. To ensure this, it may be suitable to provide the location information and the synchronization source information (e.g., SLSSID) including the quality of the synchronization (e.g., synchronization source type or the level of the synchronization source) in the assistance data sent from the anchor UEs 105A to the target UE 105T for positioning. Then, the target UE 105T may be able to report the difference of the two RSTD measurements if the synchronization source, the anchor UEs 105A, and the relative locations associated with the RSTD measurements are the same. In some embodiments, this information may be carried by the first-stage SCI, the second-stage SCI, MAC CE, or RRC configuration (e.g., when a unicast/groupcast link is established between the anchor UEs 105A and the target UE 105T).

In some embodiments, to reduce the overhead, an anchor UE 105A may include only an indication that its synchronization source and that its location have not changed (e.g., in case of a roadside unit that is fixed). This indication may be carried in the first-stage SCI, carried in the second-stage SCI, carried as a MAC CE, or carried by RRC configuration. For example, the anchor UEs 105A may use a one-bit field in the second-stage SCI to indicate that the synchronization source and the relative location have not changed. In addition, the validity (e.g., the validity time) of the provided location/synchronization source information may be identified. The validity may depend on the type of the anchor UE 105A. For example, if the anchor UE 105A is an RSU, then the validity timer of the anchor UE 105A may be relatively long. On the other hand, a vehicle as an anchor UE 105A might have a shorter validity timer. In this case, the validity timer may be configured (e.g., pre-configured) per resource pool.

In some embodiments, periodicity, during which the indication of the same synchronization source and same relative location may be sent, may differ based on the UE type. For example, if the anchor UE 105A is an RSU, the synchronization source and location might not significantly change. Thus, an anchor UE 105A that is an RSU may send the indication with a much larger period when compared to a vehicle UE. In some embodiments, the target UE 105T may report the two RSTD measurements that are associated with each other. In some embodiments, the target UE 105T may report the difference of the two RSTD measurements that are associated with each other.

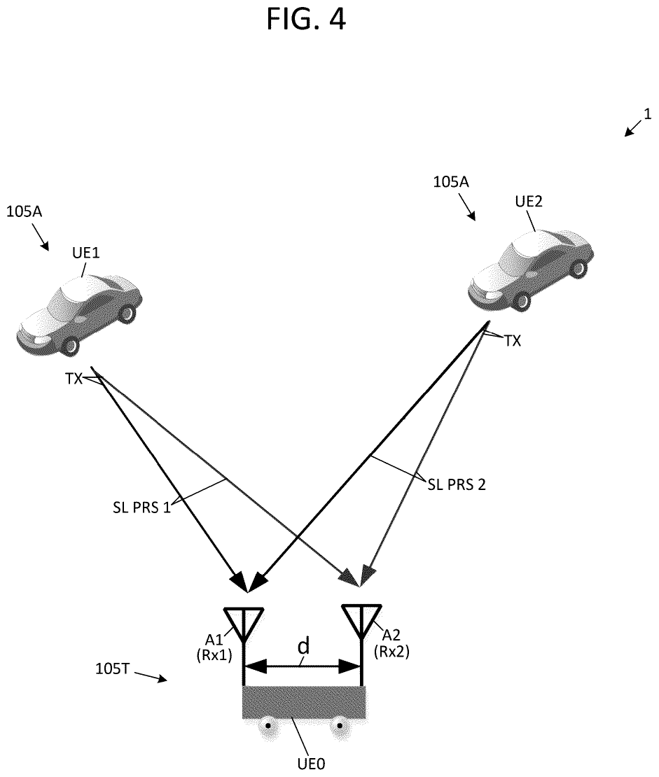

FIG. 4 is a block diagram depicting a system for mitigating an impact of synchronization errors using multiple antennas from a single target UE, according to some embodiments of the present disclosure.

Referring to FIG. 4, the target UE 105T includes the first antenna A1 (also referred to as Rx1) and the second antenna A2 (also referred to as Rx2), which are separated by the distance d. In some embodiments, the target UE 105T may use two different antenna panels corresponding to the first antenna A1 and the second antenna A2 to perform two RSTD measurements (e.g., two simultaneous RSTD measurements) based on the same received SL PRS resources, provided that the synchronization error and relative locations of the anchor UEs 105A do not change. For example, the target UE 105T (e.g., UE0) may be a vehicle having a front antenna as the first antenna A1 and a rear antenna as the second antenna A2. The antennas may be relatively large (e.g., larger than a cell phone antenna). A first anchor UE 105A (e.g., UE1) may send its signal SL PRS 1 to the target UE 105T. A second anchor UE 105A (e.g., UE2) may send its signal SL PRS 2 to the target UE 105T. The target UE 105T may, thereby, receive both signals SL PRS 1 and SL PRS 2 at each antenna, the first antenna A1 and the second antenna A2. The target UE 105T may perform two concurrent or substantially simultaneous RSTD measurements based on the same SL PRS resources corresponding to SL PRS 1 and SL PRS 2.

In a measurement report for the two simultaneous RSTD measurements, the target UE 105T may include the antenna panel index associated with each RSTD measurement and/or the difference between the two RSTD measurements. The impact of the synchronization error between the anchor UEs 105A may be mitigated because the synchronization source and the location of the synchronization source is substantially constant between the two RSTD measurements. In some embodiments, the target UE 105T may report the two RSTD measurements or their difference using the SCI, MAC CE, or RRC signaling to reduce the latency involved in decoding the payload compared with sending the report over the sidelink. In some embodiments, the target UE may report the two RSTD measurements or their difference over the Uu link to a nearby network node 110 (see FIG. 1) in an assigned physical uplink control channel (PUCCH).

The impact of the synchronization error between the anchor UEs 105A (UE1 and UE2) may be mitigated based on taking the difference between the two RSTD measurements performed at the two antennas RX1 and RX2 in accordance with the following. Assuming that the geometric coordinates for UE0, UE1, and UE2 are (x,y), (x₁,y₁), (x₂,y₂), wherein (x₁,y₁), (x₂,y₂) are known. The real transmit time for UEi may be:

$$t + {T}_{i} ( t , {t}_{i}^{s y n c} , {ε}_{i} ) \qquad ( equation 2. )$$

wherein t is the ideal transmit time, and wherein Tᵢ(t, tᵢ^{sync}, εᵢ) is time offset between real transmit time and ideal transmit time, which is a function of ideal transmit time t, the time at which synchronization was done tᵢ^{sync}, and the synchronization error of UEi, εᵢ. The measurement error for the receive time at UE0 may be negligible. If the distance between the two Rx antennas, Rx1 and Rx2, is d, then the geometric coordinates for Rx1 and Rx2 may be:

$$( x - d / 2 , y ) ( x + d / 2 , y ) . \qquad ( equation 2.1 )$$

Then at antenna Rx1 of UE0, the RSTD measurement between UE1 and UE2 may be given by (equation 2.2):

$$R S T {D}_{1 , 2}^{R x 1} = \frac{\sqrt[2]{{( x - \frac{d}{2} - {x}_{1} )}^{2} + {( y - {y}_{1} )}^{2}}}{c} - \frac{\sqrt[2]{{( x - \frac{d}{2} - {x}_{2} )}^{2} + {( y - {y}_{2} )}^{2}}}{c} + {T}_{1} ( t , {t}_{1}^{s y n c} , {ε}_{1} ) - {T}_{2} ( t , {t}_{2}^{s y n c} , {ε}_{2} ) ,$$

Similarly, at antenna Rx2, the RSTD measurement between UE1 and UE2 is given by (equation 2.3):

$$R S T {D}_{1 , 2}^{R x 2} = \frac{\sqrt[2]{{( x + \frac{d}{2} - {x}_{1} )}^{2} + {( y - {y}_{1} )}^{2}}}{c} - \frac{\sqrt[2]{{( x + \frac{d}{2} - {x}_{2} )}^{2} + {( y - {y}_{2} )}^{2}}}{c} + {T}_{1} ( t , {t}_{1}^{s y n c} , {ε}_{1} ) - {T}_{2} ( t , {t}_{2}^{s y n c} , {ε}_{2} ) ,$$

If the two RSTD measurements at antenna Rx1 and Rx2 are taken at the same time (or closely in time), the real time difference T₁(t, t₁^{sync}, ε₁)−T₂(t, t₂^{sync}, ε₂) between UE1 and UE2 remains the same. Thus, the impact of the real time difference between UE1 and UE2 may be mitigated by taking the difference between the two RSTD measurements performed at the two Rx antennas (e.g., the first antenna A1 and the second antenna A2).

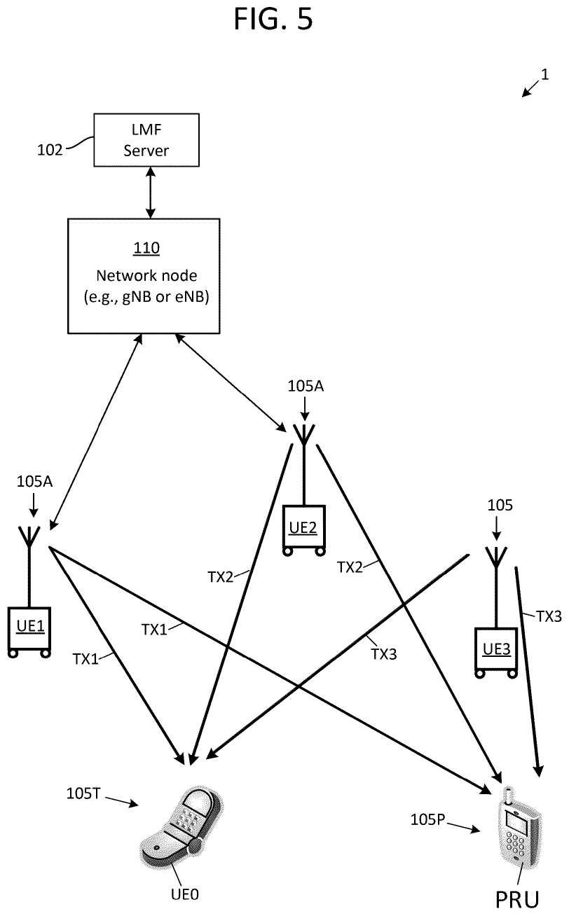

FIG. 5 is a block diagram depicting a system for mitigating an impact of synchronization errors using a positioning reference unit (PRU), according to some embodiments of the present disclosure.

Referring to FIG. 5, the system 1 may include multiple UEs 105, a network node 110, and an LMF server 102. The UEs 105 may include a target UE 105T, a PRU 105P, and at least two anchor UEs 105A. As discussed above, transmission time errors for RSTD measurements may include a synchronization error, which is related to the synchronization source. The synchronization error may depend on synchronization source quality (e.g., whether the anchor UE 105A is directly or indirectly synchronized to a GNSS, a gNB, etc.), and may depend on propagation delay between the anchor UE 105A and the synchronization source (e.g., the level of the synchronization source). In some embodiments, a PRU 105P may be utilized for mitigating the time error between different anchor UEs 105A for SL TDOA. In such embodiments, the underlying assumption is that the location information of a PRU 105P and the anchor UEs 105A are known by the system 1. In some embodiments, the PRU 105P may be selected and activated by the LMF server 102 if the UEs 105 are in coverage.

In some embodiments, the target UE 105T (e.g., UE0) and the PRU 105P may perform RSTD measurements on SL PRS resources from the same set of anchor UEs 105A at the same time. In some embodiments, the PRU 105P may be triggered to participate in the SL-TDOA process by receiving a request from an anchor UE 105A, from the target UE 105T, from the network node 110, or from an RSU. In some embodiments, to reduce latency, the request may be carried by signaling on a physical layer.

For example, the request may be sent in the first-stage SCI, in the second-stage SCI, in the MAC CE, or in the RRC signaling. In triggering the request, the anchors (e.g., UEs, gNB, or RSUs) that will be used by the target UE 105T may be notified about the PRU 105P, so that the two RSTD measurements may be based on the same anchors. For example, the target UE 105T and the PRU 105P may perform the RSTD measurements on the same set of SL PRS resources sent from the same set of anchors.

Similar to the solution of using two Rx antennas, which is discussed above in reference to FIG. 4, the following may be assumed. The geometric coordinates for target UE 105T, the potential anchor UEs 105A (e.g., UE1, UE2, UE3), and the PRU 105P are:

$$( x , y ) ( {x}_{1} , {y}_{1} ) , ( {x}_{2} , {y}_{2} ) ( {x}_{3} , {y}_{3} ) , ( {x}_{P R U} , {y}_{P R U} ) \qquad ( equation 3.1 )$$

wherein (x₁, y₁), (x₂, y₂), (x₃, y₃), (x_{PRU}, y_{PRU}) are known. The real transmit time for UEi (e.g., a given anchor UE 105A) may be:

$$t + {T}_{i} ( t , {t}_{i}^{s y n c} , {ε}_{i} ) , \qquad ( equation 3.2 )$$

wherein t is the ideal transmit time, and wherein Tᵢ(t, tᵢ^{sync}, εᵢ) is the time offset between the real transmit time and ideal transmit time, which is a function of ideal transmit time, of the time at which synchronization was done tᵢ^{sync}, and of the synchronization error of UEi, εᵢ. The measurement error for the receive time at UE0 may be negligible.

Then at PRU 105P, the RSTD measurement between selected anchor UEs 105A (e.g., UE1 and UE2) may given by (equation 3.3):

$$R S T {D}_{1 , 2}^{P R U} = \frac{\sqrt[2]{{( {x}_{P R U} - {x}_{1} )}^{2} + {( {y}_{P R U} - {y}_{1} )}^{2}}}{c} - \frac{\sqrt[2]{{( {x}_{P R U} - {x}_{2} )}^{2} + {( {y}_{P R U} - {y}_{2} )}^{2}}}{c} + {T}_{1} ( t , {t}_{1}^{s y n c} , {ε}_{1} ) - {T}_{2} ( t , {t}_{2}^{s y n c} , {ε}_{2} )$$

Then the real time difference T₁(t, t₁^{sync}, ε₁)−T₂(t, t₂^{sync}, ε₂) between UE1 and UE2 may be calculated through the RSTD measurement, provided that the locations of UE1, UE2, and the PRU 105P are known. To utilize the real transmit-time difference estimation provided by the PRU 105P, the RSTD measurements taken at the target UE 105T and the PRU 105P may ensure that the transmit time offsets at the anchor UEs 105A (e.g., UE1 and UE2) do not change between measurements. The transmit time offsets at the anchor UEs 105A may be maintained by having the target UE 105T and the PRU 105P perform RSTD measurements between the two anchor UEs 105A at the same time (or closely in time).

An RSTD measurement, performed by the target UE 105T and associated with the two anchor UEs 105A (e.g., UE1 and UE2), may be configured by the LMF server 102 or the network node 110 to be associated with another RSTD measurement, which is performed by the PRU 105P and is associated with the same pair of anchor UEs 105A (e.g., UE1 and UE2).

The LMF server 102 or the network node 110 may be aware of the anchors and/or the PRU, which may be selected by the target UE 105T, through signaling. For example, a request may be sent in the first-stage SCI, second-stage SCI, MAC CE, or RRC configuration. In some embodiments, the LMF server 102 or network node 110 may be enabled to request the UEs 105, including the target UE 105T and PRU 105P, to perform measurements on indicated SL PRS resources occurring within indicated (e.g., specified) time windows. In some embodiments, to compensate for the underlying dynamic environment of the system 1, the LMF server 102 or network node 110 may provide a time window to the UEs 105 within which any two RSTD measurements performed by the target UE 105T and the PRU 105P may be considered as associated (e.g., linked).

For example, the LMF server 102 or the network node 110 may configure a time range corresponding to (e.g., centered at) the timestamp when the target UE 105T performs its measurement. Then, all the measurements taken by the PRU 105P within the time range may be associated with the measurement taken at the target UE 105T. If multiple measurements from the PRU 105P are associated with the measurement from the target UE 105T, then association may only be valid for the pair of measurements (one from the PRU 105P and one from the target UE 105T) with the smallest time difference between the timestamps corresponding to the measurements. With two measurements being associated, the real transmit time difference estimated by the PRU 105P may be applied to the RSTD measurement taken by the target UE 105T for mitigating the impact of transmit time error.

In some embodiments, the PRU 105P may send its RSTD measurements to the target UE 105T in the assistance data carried by the physical sidelink shared channel (PSSCH), MAC CE, or PC5 RRC. In some embodiments, the PRU 105P may derive RTD information from its RSTD measurement, and may send the RTD information to the target UE 105T. RTD refers to the time difference between the actual transmission times of the two anchor UEs 105A. In some embodiments, the LMF server 102 may calculate the position of the target UE 105T, and may perform post-processing (e.g., subtracting the errors from the measurements).

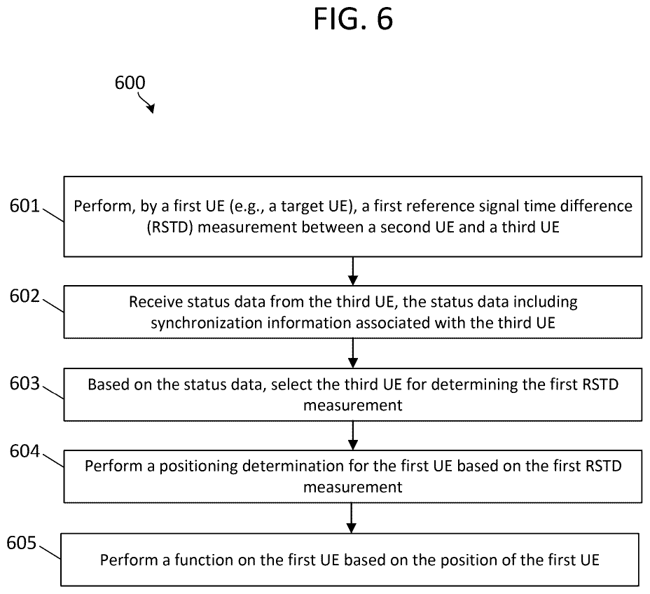

FIG. 6 is a flowchart depicting a method for performing SL positioning, according to some embodiments of the present disclosure.

Referring to FIG. 6, a method 600 for performing positioning on a sidelink may include one or more of the following operations. A first UE 105 (e.g., a target UE 105T) may perform a first RSTD measurement between a second UE (e.g., an anchor UE that is a reference UE) and a third UE (e.g., an anchor UE) (operation 601). For example, an application running on the target UE 105T may request the position of the target UE 105T, and the processing circuit 120 of the target UE 105T may cause a positioning process to be implemented within the system 1. The target UE 105T may perform the first RSTD measurement as part of the positioning process.

To perform the first RSTD measurement, the target UE 105T, another UE 105, and/or the LMF server 102 may receive status data SD from the third UE 105 (operation 602). The status data SD may include synchronization information associated with the third UE 105 (operation 602). For example, the synchronization information may indicate the following: (i) how long since the second UE 105 last synchronized with its synchronization source; (ii) a quality of the synchronization source (e.g., via a synchronization-source quality indicator, such as SLSSID, synchronization level, direct or indirect synchronization); (iii) a synchronization source type (e.g., GNSS, gNB/eNB, or UE) associated with the anchor UEs 105A (e.g., of the potential anchor UEs 105A); and (iv) an RTD between anchor UEs 105A (e.g., between the potential anchor UEs 105A). In other words, to mitigate the impact of synchronization errors between anchor UEs 105A for SL-PRS-based measurements, synchronization information of potential anchor UEs 105A may be exchanged. Based on the status data SD, the target UE 105T, the LMF server 102, or another UE 105 (e.g., an anchor UE 105A) may select the third UE 105 for determining an RSTD measurement (e.g., may select the third UE 105 to participate, as an anchor UE 105A, in an SL-TDOA process for the positioning process) (operation 603).

The target UE 105T may determine its location (e.g., may perform a positioning determination) based on the first RSTD measurement (operation 604). The target UE 105T may perform a function on the target UE 105T based on the position (e.g., based on location data), which may be generated based on the location of the target UE 105T (operation 605). For example, the target UE 105T may provide its location information to the application running on the target UE 105T to complete the request from the application. The location information may be more accurate and/or more precise location information based on receiving and analyzing the status data SD during the positioning process.

The present disclosure is not limited to the sequence or number of the operations of the method 600 shown in FIG. 6, and can be altered into any desired sequence or number of operations as recognized by a person having ordinary skill in the art. For example, in some embodiments, the order may vary, some processes thereof may be performed concurrently or sequentially, or the method 600 may include fewer or additional operations.

FIG. 7 is a block diagram of an electronic device in a network environment, according to some embodiments of the present disclosure.

Referring to FIG. 7, an electronic device 701 in a network environment 700 may communicate with an electronic device 702 via a first network 798 (e.g., a short-range wireless communication network). The electronic device 701 in a network environment 700 may communicate with an electronic device 704 or a server 708 via a second network 799 (e.g., a long-range wireless communication network). The electronic device 701 may communicate with the electronic device 704 via the server 708. The electronic device 701 may include a processor 720, a memory 730, an input device 750, a sound output device 755, a display device 760, an audio module 770, a sensor module 776, an interface 777, a haptic module 779, a camera module 780, a power management module 788, a battery 789, a communication module 790, a subscriber identification module (SIM) card 796, and/or an antenna module 797. In one or more embodiments, at least one of the components (e.g., the display device 760 or the camera module 780) may be omitted from the electronic device 701. In one or more embodiments, one or more other components may be added to the electronic device 701. Some of the components may be implemented as a single integrated circuit (IC). For example, the sensor module 776 (e.g., a fingerprint sensor, an iris sensor, or an illuminance sensor) may be embedded in the display device 760 (e.g., a display).

The processor 720 may execute software (e.g., a program 740) to control at least one other component (e.g., a hardware or a software component) of the electronic device 701 coupled to the processor 720, and may perform various data processing or computations.

As at least part of the data processing or computations, the processor 720 may load a command or data received from another component (e.g., the sensor module 776 or the communication module 790) in volatile memory 732, may process the command or the data stored in the volatile memory 732, and/or may store resulting data in non-volatile memory 734. The processor 720 may include a main processor 721 (e.g., a CPU or an application processor (AP)), and may also include an auxiliary processor 723 (e.g., a graphics processing unit (GPU), an image signal processor (ISP), a sensor hub processor, or a communication processor (CP)) that is operable independently from, or in conjunction with, the main processor 721. Additionally or alternatively, the auxiliary processor 723 may be adapted to consume less power than the main processor 721, or to execute a particular function. The auxiliary processor 723 may be implemented as being separate from, or a part of, the main processor 721.

The auxiliary processor 723 may control at least some of the functions or states related to at least one component (e.g., the display device 760, the sensor module 776, or the communication module 790), as opposed to the main processor 721 while the main processor 721 is in an inactive/sleep state, or together with the main processor 721 while the main processor 721 is in an active state (e.g., while executing an application). The auxiliary processor 723 (e.g., an image signal processor or a communication processor) may be implemented as part of another component (e.g., the camera module 780 or the communication module 790) functionally related to the auxiliary processor 723.

The memory 730 may store various data used by at least one component (e.g., the processor 720 or the sensor module 776) of the electronic device 701. The various data may include, for example, software (e.g., the program 740) and input data or output data for a command related thereto. The memory 730 may include the volatile memory 732 or the non-volatile memory 734.

The program 740 may be stored in the memory 730 as software, and may include, for example, an operating system (OS) 742, middleware 744, or an application 746.

The input device 750 may receive a command or data to be used by another component (e.g., the processor 720) of the electronic device 701. The command or data may be received from the outside (e.g., a user) of the electronic device 701. The input device 750 may include, for example, a microphone, a mouse, or a keyboard.

The sound output device 755 may output sound signals to the outside of the electronic device 701. The sound output device 755 may include, for example, a speaker or a receiver. The speaker may be used for general purposes, such as playing multimedia or recording, and the receiver may be used for receiving an incoming call. The receiver may be implemented as separate from, or as a part of, the speaker.

The display device 760 may visually provide information to the outside (e.g., to a user) of the electronic device 701. The display device 760 may include, for example, a display, a hologram device, or a projector, and may include control circuitry to control a corresponding one of the display, hologram device, and projector. The display device 760 may include touch circuitry adapted to detect a touch, or may include sensor circuitry (e.g., a pressure sensor) adapted to measure the intensity of force incurred by the touch.

The audio module 770 may convert a sound into an electrical signal, and vice versa. The audio module 770 may obtain the sound via the input device 750, or may output the sound via the sound output device 755 or via a headphone of an external electronic device 702, which may be directly (e.g., wired) or wirelessly coupled to the electronic device 701.

The sensor module 776 may detect an operational state (e.g., power or temperature) of the electronic device 701, or an environmental state (e.g., a state of a user) that is external to the electronic device 701. The sensor module 776 may then generate an electrical signal or data value corresponding to the detected state. The sensor module 776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, and/or an illuminance sensor.

The interface 777 may support one or more specified protocols to be used for the electronic device 701 to be coupled to the external electronic device 702 directly (e.g., wired) or wirelessly. The interface 777 may include, for example, a high-definition multimedia interface (HDMI), a universal serial bus (USB) interface, a secure digital (SD) card interface, or an audio interface.

A connecting terminal 778 may include a connector via which the electronic device 701 may be physically connected to the external electronic device 702. The connecting terminal 778 may include, for example, an HDMI connector, a USB connector, an SD card connector, and/or an audio connector (e.g., a headphone connector).

The haptic module 779 may convert an electrical signal into a mechanical stimulus (e.g., a vibration or a movement) and/or an electrical stimulus, which may be recognized by a user via tactile sensation or kinesthetic sensation. The haptic module 779 may include, for example, a motor, a piezoelectric element, and/or an electrical stimulator.

The camera module 780 may capture a still image or moving images. The camera module 780 may include one or more lenses, image sensors, image signal processors, or flashes. The power management module 788 may manage power that is supplied to the electronic device 701. The power management module 788 may be implemented as at least part of, for example, a power management integrated circuit (PMIC).

The battery 789 may supply power to at least one component of the electronic device 701. The battery 789 may include, for example, a primary cell that is not rechargeable, a secondary cell that is rechargeable, or a fuel cell.

The communication module 790 may support establishing a direct (e.g., wired) communication channel, or a wireless communication channel, between the electronic device 701 and the external electronic device (e.g., the electronic device 702, the electronic device 704, or the server 708), and may support performing communication via the established communication channel. The communication module 790 may include one or more communication processors that are operable independently from the processor 720 (e.g., the AP), and may support a direct (e.g., wired) communication or a wireless communication. The communication module 790 may include a wireless communication module 792 (e.g., a cellular communication module, a short-range wireless communication module, or a global navigation satellite system (GNSS) communication module), or may include a wired communication module 794 (e.g., a local area network (LAN) communication module or a power line communication (PLC) module). A corresponding one of these communication modules may communicate with the external electronic device via the first network 798 (e.g., a short-range communication network, such as BLUETOOTH™, wireless-fidelity (Wi-Fi) direct, or a standard of the Infrared Data Association (IrDA)), or via the second network 799 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 792 may identify and authenticate the electronic device 701 in a communication network, such as the first network 798 or the second network 799, using subscriber information (e.g., international mobile subscriber identity (IMSI)) stored in the subscriber identification module 796.

The antenna module 797 may transmit or may receive a signal or power to or from the outside (e.g., the external electronic device) of the electronic device 701. The antenna module 797 may include one or more antennas. The communication module 790 (e.g., the wireless communication module 792) may select at least one of the one or more antennas appropriate for a communication scheme used in the communication network, such as the first network 798 or the second network 799. The signal or the power may then be transmitted or received between the communication module 790 and the external electronic device via the selected at least one antenna.

Commands or data may be transmitted or received between the electronic device 701 and the external electronic device 704 via the server 708 coupled to the second network 799. Each of the electronic devices 702 and 704 may be a device of a same type as, or a different type from, the electronic device 701. All or some of operations to be executed at the electronic device 701 may be executed at one or more of the external electronic devices 702, 704, or the server 708. For example, if the electronic device 701 should perform a function or a service automatically, or in response to a request from a user or another device, the electronic device 701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 701. The electronic device 701 may provide the outcome, with or without further processing of the outcome, as at least part of a reply to the request. To that end, cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations may be depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims, with functional equivalents thereof to be included therein.

What is claimed is:

1. A method comprising:
performing, by a first user equipment (UE), a first measurement between a second UE and a third UE;
receiving status data from the third UE, the status data comprising synchronization information associated with the third UE;
based on the status data, selecting the third UE for determining the first measurement; and
performing a positioning determination based on the first measurement.

2. The method of claim 1, wherein:
the first UE serves as a target UE;
the second UE serves as a reference UE;
the third UE serves as an anchor UE; and
the synchronization information comprises at least one of a synchronization source type associate with the third UE or a relative time difference (RTD) associated with the second UE and the third UE.

3. The method of claim 2, wherein:
the target UE has a position to be determined and performs the first measurement;
the reference UE has a known position and sends a first signal to the target UE for performing the first measurement; and
the anchor UE participates in the first measurement by sending a second signal to the target UE for performing the first measurement.

4. The method of claim 1, wherein the synchronization information indicates a length of time since the third UE synchronized with a synchronization source.

5. The method of claim 1, wherein the synchronization information indicates a synchronization-source quality.

6. The method of claim 1, further comprising:
performing, by the first UE, a second measurement between the second UE and the third UE; and
sending, by the first UE, an indication that the first measurement or the second measurement can be used to determine a clock drift of the first UE.

7. The method of claim 6, further comprising sending, by the first UE, the first measurement and the second measurement in a same message.

8. The method of claim 6, further comprising sending, by the first UE, the first measurement and the second measurement in different messages.

9. The method of claim 1, further comprising:
performing, by a positioning reference unit (PRU), a second measurement between the second UE and the third UE; and
associating the first measurement with the second measurement.

10. The method of claim 1, wherein:
the first UE comprises a first antenna and a second antenna separated from each other by a distance;
the performing the first measurement comprises performing the first measurement with respect to the first antenna; and
the method further comprises:
performing a second measurement with respect to the second antenna; and
determining a position of the first UE based on the first measurement, based on the second measurement, and based on the distance.

11. A first user equipment (UE) comprising a processing circuit, wherein the processing circuit is configured to perform:
a first measurement between a second UE and a third UE;
receiving status data from the third UE, the status data comprising synchronization information associated with the third UE;
based on the status data, selecting the third UE for determining the first measurement; and
a positioning determination based on the first measurement.

12. The first UE of claim 11, wherein the synchronization information comprises at least one of a synchronization source type associated with the third UE or a relative time difference (RTD) associated with the second UE and the third UE.

13. The first UE of claim 11, wherein the synchronization information indicates:
a length of time since the third UE synchronized with a synchronization source; or
a synchronization-source quality.

14. The first UE of claim 11, wherein the processing circuit is configured to perform:
a second measurement between the second UE and the third UE; and
sending an indication that the first measurement or the second measurement can be used to determine a clock drift of the first UE.

15. A system comprising:
a processing circuit; and
a memory for storing instructions, which, when executed by the processing circuit, cause the processing circuit to perform:
causing a first user equipment (UE) to perform a first measurement between a second UE and a third UE;
receiving status data from the third UE, the status data comprising synchronization information associated with the third UE;
based on the status data, selecting the third UE for determining the first measurement; and
a positioning determination based on the first measurement.

16. The system of claim 15, wherein the synchronization information comprises at least one of a synchronization source type associated with the third UE or a relative time difference (RTD) associated with the second UE and the third UE.

17. The system of claim 15, wherein the synchronization information indicates a length of time since the third UE synchronized with a synchronization source.

18. The system of claim 15, wherein the synchronization information indicates a synchronization-source quality.

19. The system of claim 15, wherein the instructions, when executed by the processing circuit, cause the processing circuit to perform:
causing the first UE to perform a second measurement between the second UE and the third UE; and
causing the first UE to send an indication that the first measurement or the second measurement can be used to determine a clock drift of the first UE.

20. The system of claim 19, wherein the instructions, when executed by the processing circuit, cause the processing circuit to perform causing the first UE to send the first measurement and the second measurement in a same message.
